(19) United States
(12) Patent Application Publication
(10) Pub. No.: US 2006/0108358 A1
(43) Pub. Date: May 25, 2006

(54) Method for straightening and curling hair using microwaves that is also permanent

(76) Inventor: Chris Baldwin Bell, Philadelphia, PA (US)

Correspondence Address: Chris Baldwin Bell, 727 South 22nd St., Philadelphia, PA, 19146, US

(21) Appl. No.: 10/995,627

(22) Filed: Nov. 22, 2004

(51) Int. Cl. H05B 6/64

(52) U.S. Cl. 219/678

(57) ABSTRACT

This invention is a method for straightening and curling hair using microwaves that is also permanent. The magnetron produces a beam of microwaves that produces heat from moisture in hair. When used in a hair appliance the microwave beams heat the moisture in the hair causing a long lasting or permanent curling or straightening effect without the use of harsh chemicals. To protect the patron whose hair is being styled from the microwave radiation, shields are built into the appliance and the appliance. Small perforations are built into the appliance to allow steam to escape so the patron is not burned.

This is a new use for the microwave. The magnetron produces a beam of microwaves that produces heat from moisture in hair. When used in a hair appliance the microwave beams heat the moisture in the hair causing a long lasting or permanent curling or straightening effect without the use of harsh chemicals. To protect the patron whose hair is being styled from the microwave radiation, shields are built into the appliance and the appliance will not operate unless the shield is in place guarding the patron from the microwave.

The shields are made from a ferrite or microwave absorbing material. This can include, but is not limited to the clear glass or plastic material in the door of a microwave oven.

The ferrite substance surrounds the magnetron except for where the microwave energy emanates. The magnetron may have microwave safe glass or plastic where the microwave radiation emanates. The glass or plastic casing or styling tool can be either smooth or it may have built in combs to aid straightening or curling hair. Ventilation is built into the casing to allow steam from the hair to escape without burning the patron's skin. An absorbent material may also be attached to the appliance to prevent steam from burning the patron.

A sensor can be used to monitor and control temperature and moisture in the patron's hair.

The magnetron can be either in the styling appliance tool or it can be in a base unit and the microwave energy can be delivered to the styling tool via a flexible microwave antenna. The microwave antenna is covered in a ferrite or microwave absorbing material to protect the people using it.

If the magnetron is too heavy or awkward to be used in a styling tool it can be attached to a floor stand or separate base unit for support.

The magnetron may use a fan, lens or other device to distribute microwave energy to a confined space.

The magnetron may use a control to regulate energy or temperature.

The magnetron may use a timer.

A soft flexible, malleable ferrite or microwaveable material may be used between appliance and scalp to absorb microwave energy.

### DRAWING FIGURES

FIGS. 1 through 7 demonstrate the ways the appliance may work. These are not the only configurations that may work.

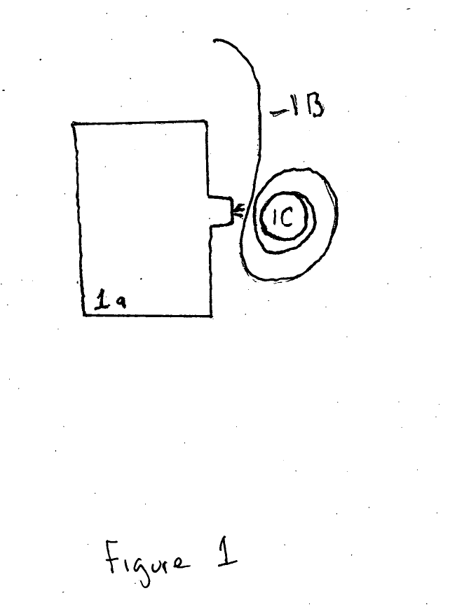

FIG. 1 shows a magnetron (a) without a microwave shield generating radiation toward hair (b) that is wound around a curler (c).

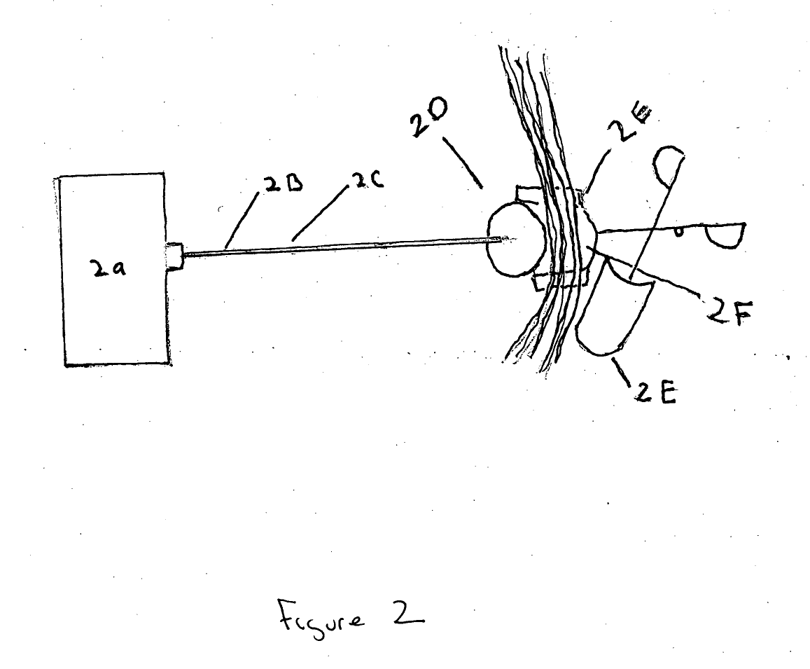

FIG. 2 shows a magnetron with a flexible microwave antenna (b) covered in a ferrite or microwave absorbing material (c) leading to a styling tool (d) that is covered with a ferrite or microwave absorbing material (e) except for where the microwave radiation emanates to style hair.

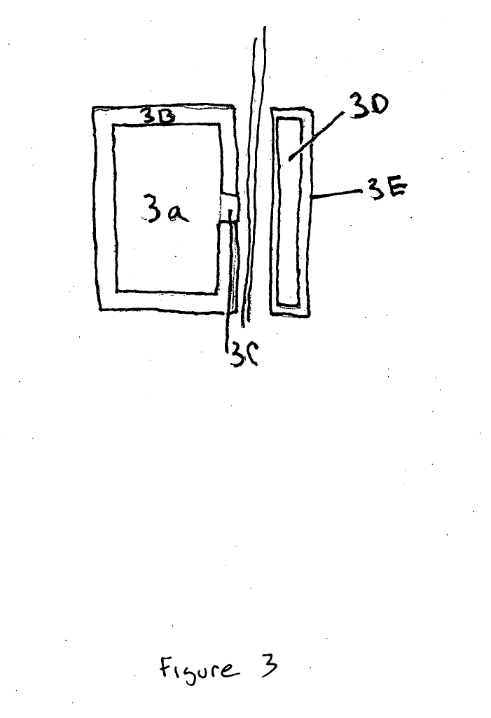

FIG. 3 shows a magnetron (a) covered in a ferrite or microwave absorbing material (b) except for where the radiation emanates (c) focusing energy on hair (d) against styling unit covered in a ferrite or microwave absorbing material (e).

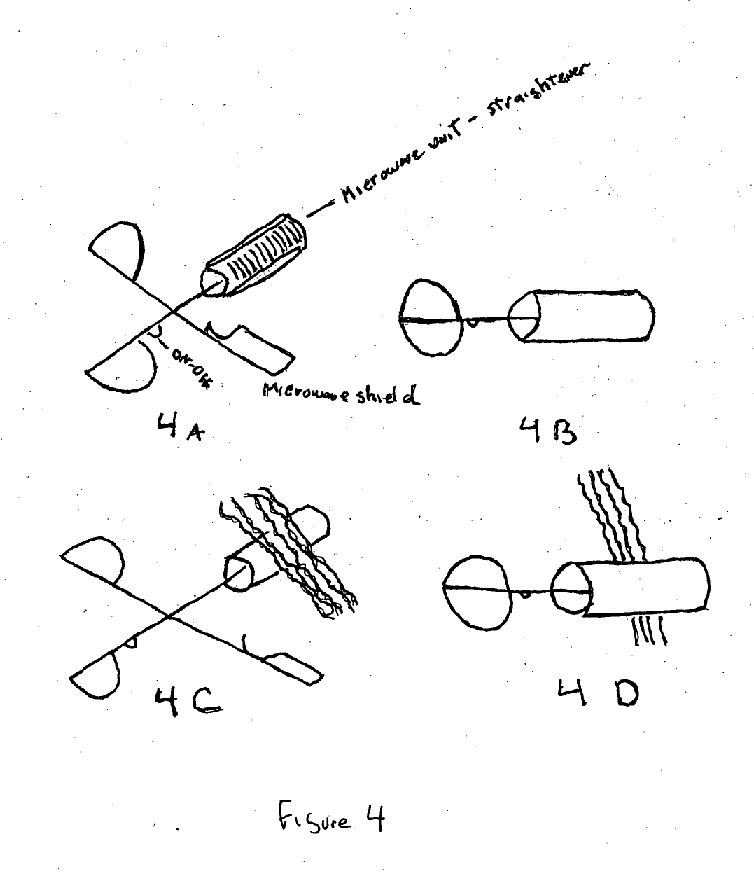

FIGS. 4 and 6 would be used for straightening or putting a slight wave in hair. The magnetron is either inside the barrel or a flexible microwave antenna is led to the barrel where microwave radiation emanates. FIGS. 4 and 6 uses a scissors style device. Hair is clamped between the scissor and when the appliance is turned on the hair is passed through and straightened or waved.

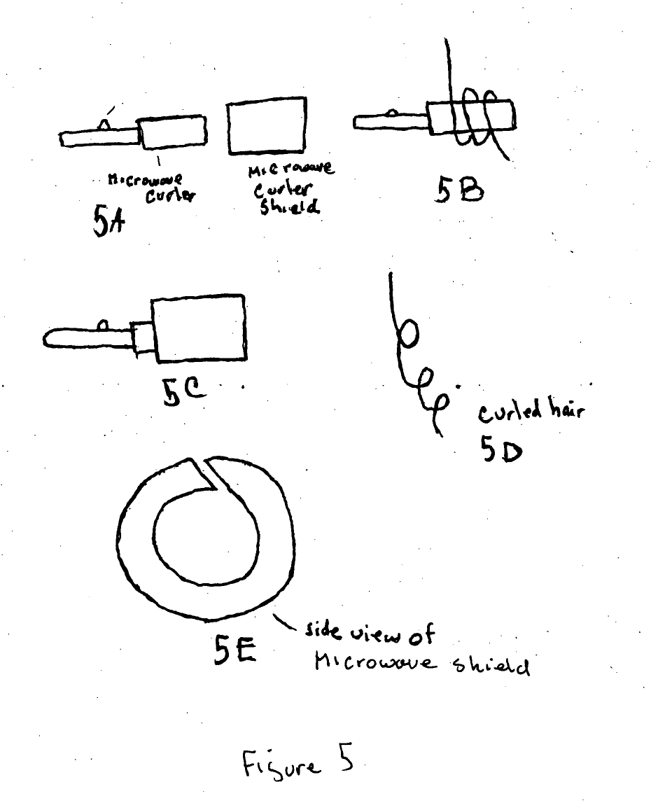

FIG. 5 is a roller style appliance. Hair is wound around the roller that covers the magnetron or contains the antenna. A microwave shield with a slanted slot for the hair is placed over the roller. When the shield is securely on the hair, the appliance is turned on and the hair is curled.

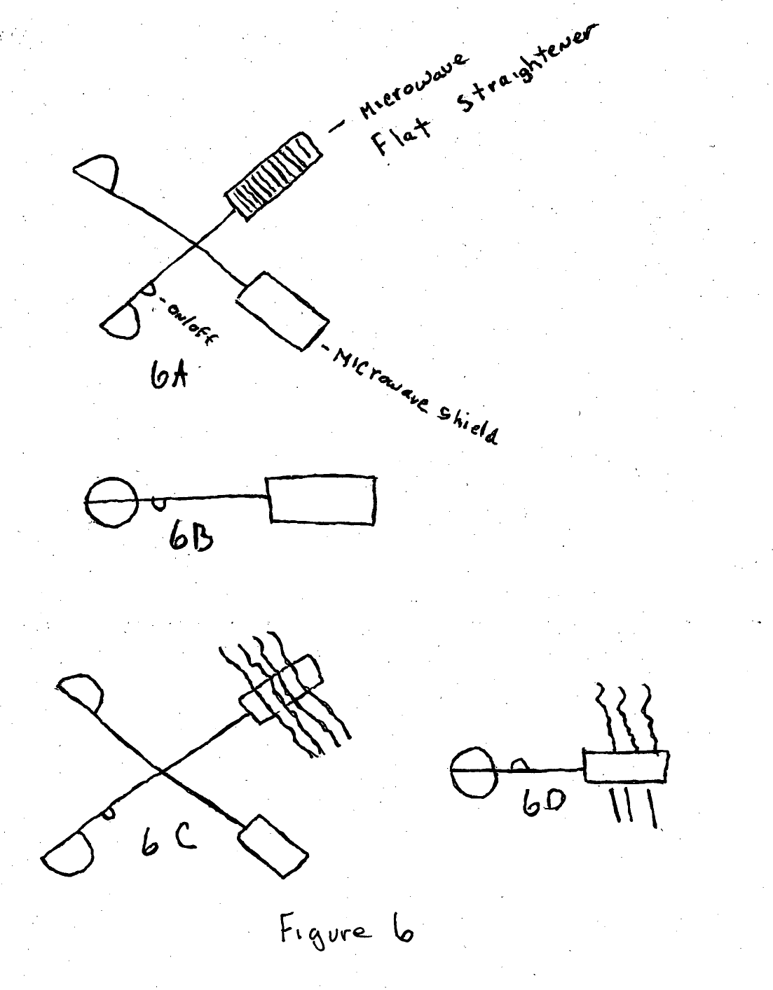

FIG. 7 has a roller with an enclosed magnetron or microwave antenna and two half shields attached to the end. Hair is wound around the roller and the two half shields snap together over the roller and the appliance is turned on and hair is curled.

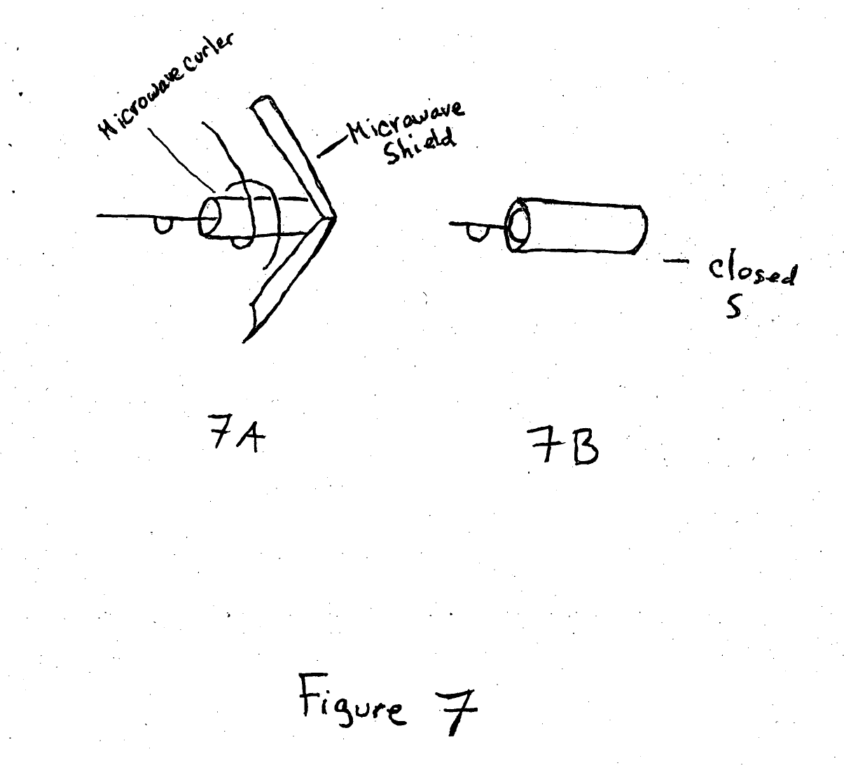

What is claimed is:

1. A method for straightening and curling hair using microwaves that is also permanent which comprises:
(i) a magnetron producing a beam of microwaves that produces heat from moisture in hair;
(ii) when used in a hair appliance the microwave beams heat the moisture in the hair causing a long lasting or permanent curling or straightening effect without the use of harsh chemicals.

2. A method according to claim 1 uses shields made from a ferrite material to protect the patron whose hair is being styled from microwave radiation:
(i) the shields are made from a ferrite or microwave absorbing material, which can include, but is not limited to the clear glass or plastic material in the door of a microwave oven;
(ii) the appliance will not operate without the shield in place guarding the patron from the microwave;
(iii) the ferrite substance surrounds the magnetron except for where the microwave energy emanates.

3. A method according to claim 1, where the magenetron may have microwave safe glass or plastic where the microwave radiation emanates:
(i) the glass or plastic casing or styling tool can either be smooth or it may have built in combs to aid straightening hair;
(ii) ventilation is built into the casing to allow steam to escape without burning the patron's skin;
(iii) an absorbent material may also be attached to the appliance to prevent steam from burning the patron.

4. A method according to claim 1 where a sensor can be used to monitor and control temperature and moisture in the patron's hair.

5. A method according to claim 1 where the magnetron can be either in the styling appliance or in the base unit and the microwave energy can be delivered to the styling tool via a flexible microwave antenna:
(i) the microwave antenna is covered in a ferrite or microwave absorbing material to protect people using it;
(ii) if the magnetron is too heavy or awkward to be used in a styling tool it can be attached to a floor stand or separate base unit for support;
(iii) the magnetron may use a fan, lens or other device to distribute microwave energy to a confined space;
(iv) the magnetron may use a control to regulate energy or temperature;
(v) the magnetron may use a timer
(vi) a soft flexible, malleable ferrite or microwave absorbing material may be used between appliance and scalp to absorb microwave energy.
